(19) United States
(12) Patent Application Publication
(10) Pub. No.: US 2009/0056355 A1
(43) Pub. Date: Mar. 5, 2009

(54) Ice Box (air intake cooler)

(76) Inventors: Mario Ross Mesa, Ontario, OR (US); Troy Alan Goff, Payette, ID (US)

Correspondence Address: TROY ALAN GOFF, 320 NORTH 10TH ST, PAYETTE, ID, 83661, US

(21) Appl. No.: 11/895,579

(22) Filed: Aug. 27, 2007

(51) Int. Cl. B60H 1/32

(52) U.S. Cl. 62/244

(57) ABSTRACT

Portions of the disclosure of this patent document may contain material, which is subject to protection. The owner has no objection to the facsimile reproduction by anyone of the patent document or the patent disclosure, as it appears in the Patent and Trademark office patent file or records, but otherwise reserves all rights whatsoever.

The Ice Box is a device that will provide cold air for injection into a combustion engine, thereby improving performance in both horsepower and fuel efficiency. This is accomplished by a cooling coil placed in the air intake path, which is filled with liquid nitrogen circulated by a centrifugal pump. The unit is then housed in a stainless steel case and mounted in the engine bay. A standard 12-volt DC motor powers the centrifugal pump.

### BACKGROUND OF INVENTION

This device will have most pertinence to the automotive field.

The enclosed drawings illustrate the general dimensions and construction of the ice box. Particular dimensions however, will be up to the manufacturer's discretion.

### BRIEF SUMMARY OF INVENTION

The Ice Box is a liquid nitrogen based air cooler that will replace existing air filter assemblies to provide enhanced performance in motor vehicle engines.

### DESCRIPTION OF VIEWS IN DRAWINGS

In the enclosed drawings,

FIG. 1 is an illustration of the exterior cooler housing.

FIG. 2 is an illustration of the cooling core with radiator fins.

FIG. 3 is an exploded illustration of the liquid nitrogen pump.

FIG. 4 is an illustration of the exterior pump housing, which will attach to the exterior cooler housing.

### DETAILED DESCRIPTION

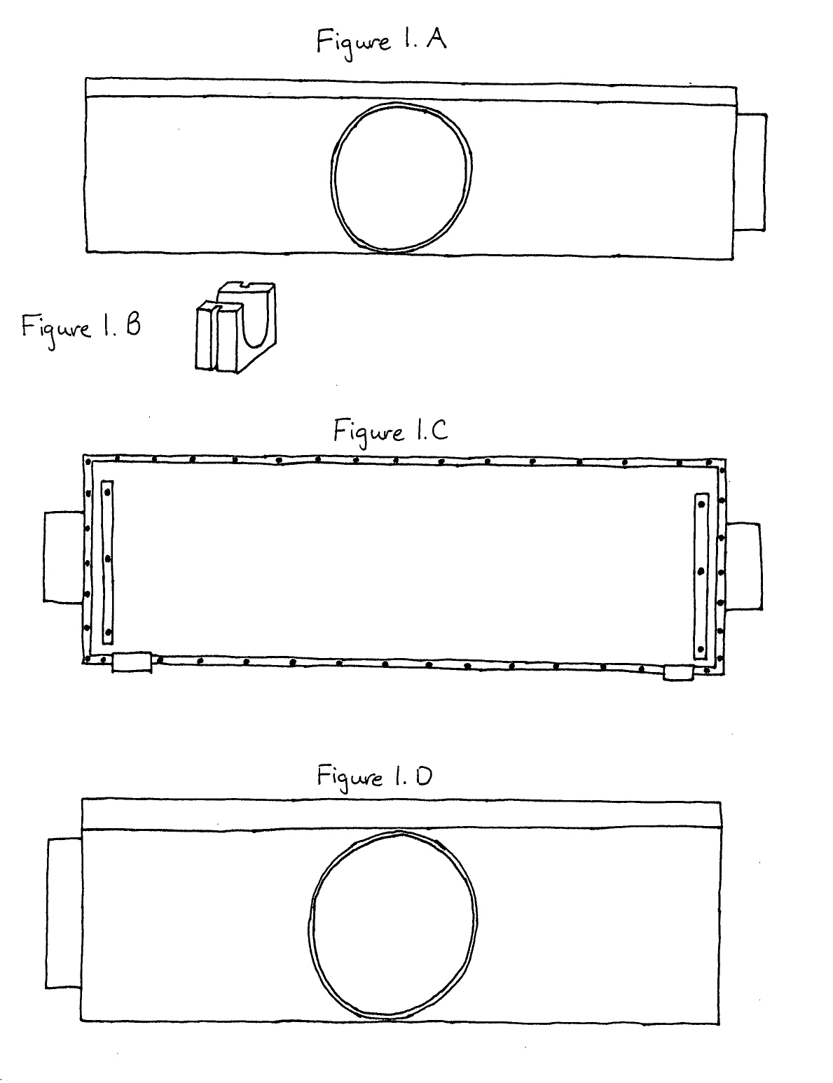

The first illustration (FIG. 1.A) is of the exterior cooler housing. This shows an intake and exhaust port for airflow. This is a simple box constructed of stainless steel. There are two stabilizers that hold the cooler core and prevent too much vibration. These stabilizers (FIG. 1.B) are composed of stainless steel and slide over a lip in the exterior cooler housing on the right side as you look at the illustration.

FIG. 1.C is an illustration of the interior of the exterior cooler housing. Although it is not pictured here, there is a lid that attaches to the housing. There are two mounting plates welded to the bottom of the exterior cooler housing, one at each end. These mounting plates are what the cooling core will be bolted to. The cooler core itself will have inlet and outlet lines exiting toward the bottom of the exterior cooler housing. The two squares drawn at the left and right bottom in FIG. 1.C are the stabilizers mentioned above (FIG. 1.B).

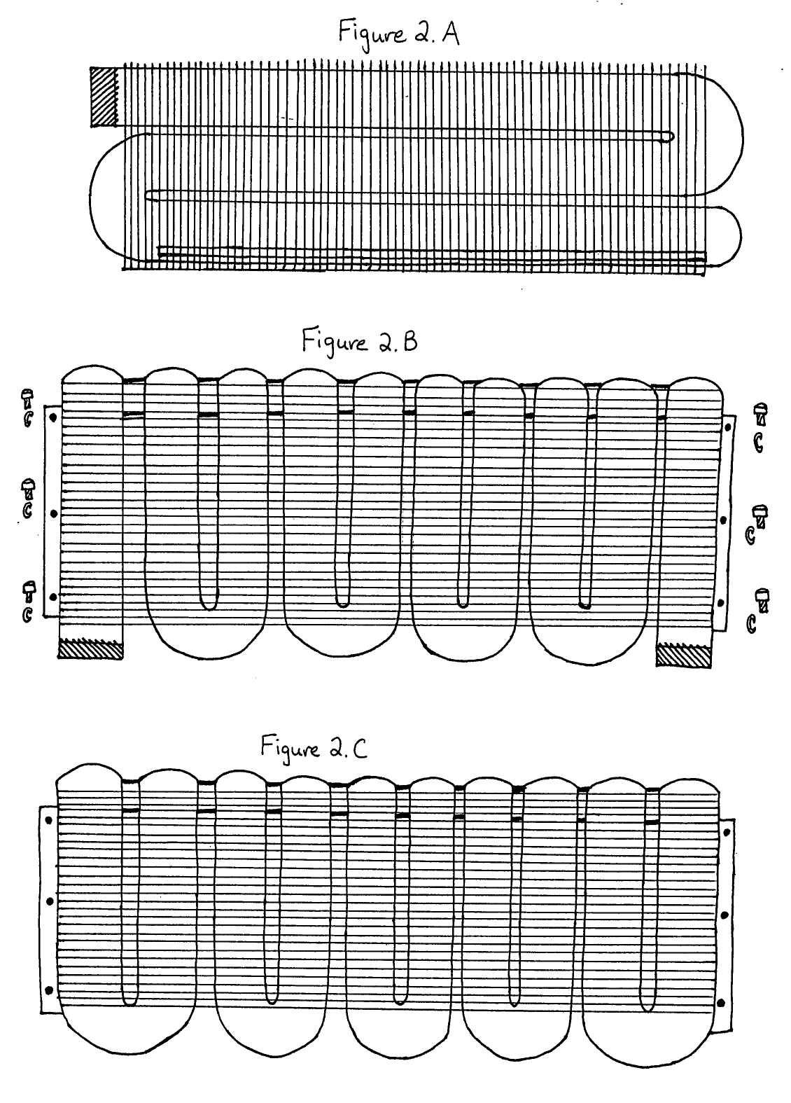

The cooler core, (FIG. 2.A) can be composed of either copper of stainless steel. The tube through which the liquid nitrogen will flow, will be routed in three vertical passes and will be welded to a mounting plate that corresponds to the mounting plate in the exterior cooler housing. FIG. 2.B shows the radiator fins running left to right. Also the mounting hardware necessary for mounting the cooler core inside the exterior cooler housing, this includes six locking washers and six bolts. Diagonal lines at the end of the tubes in the illustrations (FIG. 2.B and FIG. 2.A) are the thread patterns to attach the flexible steel braided lines. These lines connect the cooler core to the pump assembly and channel the liquid nitrogen to and from the pump.

The purpose of the cooling core is to provide a significant decrease in temperature as air passed through the Ice Box.

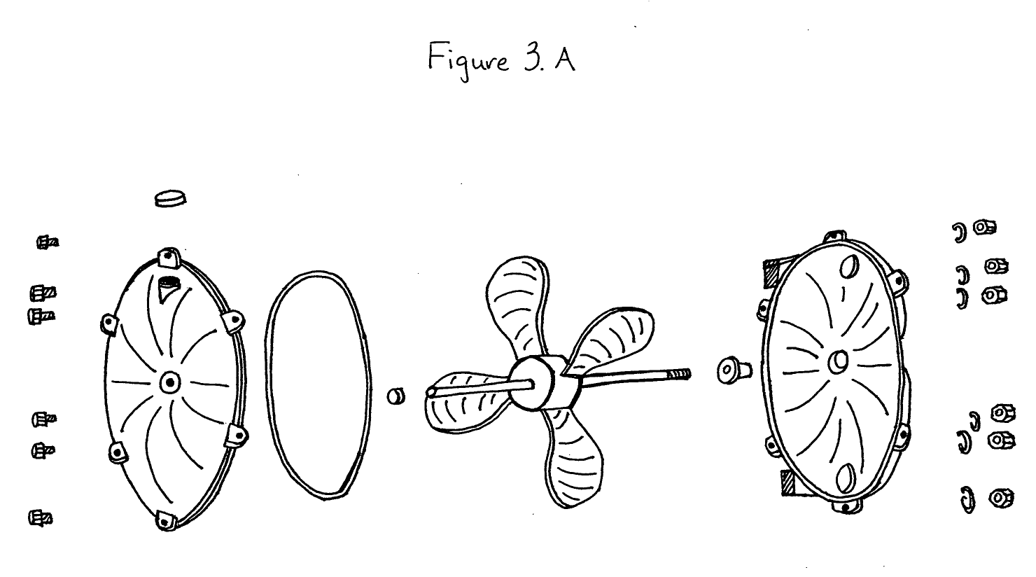

The drawing in FIG. 3.A is an exploded view of the pump assembly. From farthest left is the mounting bolts made of stainless steel. Then the backside of the pump housing, which has the filler tube for the liquid nitrogen; the cap for the filler tube is composed of Teflon. The outside of the pump housing has six areas were plates are welded on, this is were the bolts to mount both halves of the pump go through. Next is the ring like gasket from (FIG. 3.A) it is made of Teflon material and is used to seal the two halves of the pump housing together. The Teflon gasket can withstand the temperatures of the liquid nitrogen and keep the seal tight. Then there is the Teflon cap, it sits around the impeller shaft so that friction will be reduced. This cap in (FIG. 3.A) is like a cup, there are no threads and it sits in the bowl like impression on the backside half of the pump housing. The impeller shaft sits firmly inside the cap, were it can rotate freely and stay aligned.

Then in (FIG. 3.A) is the impeller shaft, this whole unit is one piece and made of stainless steel. The impeller shaft is composed of four blades slightly shaped to cup the liquid nitrogen and force it in the outlet tube. The blades are attached to a balanced weight at the base and the shaft extends in both directions from dead center of this weight. The whole impeller shaft would be made of machined stainless steel and at the end of the impeller shaft on the right side from (FIG. 3.A) the shaft would be threaded. From (FIG. 3.A) the impeller shaft (threaded side) would then slide through the Teflon made plug.

This Teflon plug is to ensure no liquid nitrogen will leak outside the pump housing and serve as an antifriction material gasket for the spinning impeller shaft inside it. The Teflon plug would be like a hollowed out tube with a larger ring at one end, all would be machined as one piece out of Teflon.

Next in (FIG. 3.A) is the front half of the pump housing with a hole in the center for the impeller shaft to exit (threaded side out). Two hollowed out tubes for the liquid nitrogen to flow through is also located on this half of the pump housing. The top tube in (FIG. 3.A) is for the liquid nitrogen to flow in from the cooling core and the bottom tube is for the blades to push the liquid nitrogen out to the cooling core. This half of the pump housing is also made of one cast of stainless steel and the ends of the tubes would be threaded for flexible stainless steel braided lines to attach to.

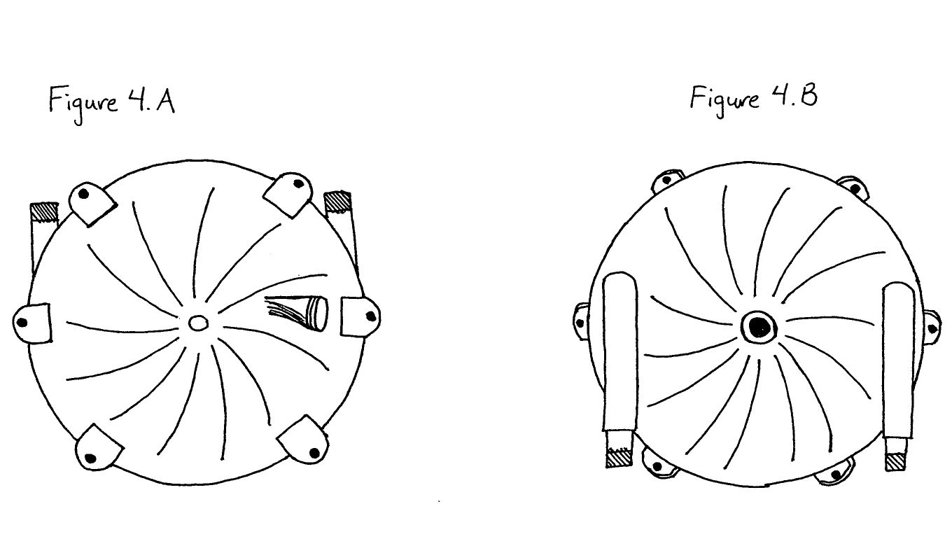

Last in (FIG. 3.A) is the six locking washers and the six threaded nuts, which would be made in either copper or stainless steel. The drawing in (FIG. 4.A) is a closer look at the pump housing from the backside. You can see it as assembled with the liquid nitrogen filler tube and Teflon cap. The drawing in (FIG. 4.B) is a closer look at the pump housing from the front side, with the center hole for the impeller shaft to exit. On the front side of the pump housing are the two tubes for the passage of liquid nitrogen to flow to and from the cooling core, these tubes are drawn with the threads on them.

In the drawing in (FIG. 4.B) were the impeller shaft with the threaded end comes out, is were a 12 volt D.C. motor needs to be attached or connect to the shaft. This 12 volt D.C. motor unit will turn the impeller shaft, this is how the blades will rotate and push the liquid nitrogen through the tubes. This 12 volt D.C. motor will operate under a single pole, single throw, toggle switch. This toggle switch will be connected to a constant positive source in the automobiles wiring, to allow the operator the choice of on or off as desired. The 12 volt D.C. motor can be any size or shape as the manufacturers may desire, it will just need to attach to the impeller shafts threaded end. In summary for all the figure drawings is just a constant flow of liquid nitrogen circulating from the cooling core, pump housing, and flexible steel braided lines to and from in a complete circle. The cooling core mounts in the exterior cooler housing and the pump housing mounts in the engine bay out of the way of moving parts and a clear path for the flexible lines to reach the exterior cooler housing.

1. The Ice Box will significantly improve the performance of virtually any motor vehicle in terms of horsepower and fuel efficiency. The degree of improvement may vary due to environment and ambient temperature. This improvement will be achieved by drastically decreasing the temperature of air as it is fed into the engine.
